(19) United States
(12) Patent Application Publication
(10) Pub. No.: US 2011/0003875 A1
(43) Pub. Date: Jan. 6, 2011

(54) Oil-Based Suspension Concentrates

(75) Inventors: Ronald Vermeer, Monheim (DE); Manuela Eberhard, Leverkusen (DE); Jurgen Kuhnhold, Bergisch Gladbach (DE)

Correspondence Address: STERNE, KESSLER, GOLDSTEIN & FOX P.L.L.C., 1100 NEW YORK AVENUE, N.W., WASHINGTON, DC, 20005, US

(73) Assignee: Bayer CropScience AG, Monheim (DE)

(21) Appl. No.: 12/919,468

(22) PCT Filed: Feb. 17, 2009
(86) PCT No.: PCT/EP2009/001087

§ 371 Date: Aug. 25, 2010

(30) Foreign Application Priority Data
Feb. 25, 2008 (EP) 08151880.5

(51) Int. Cl. A01N 43/38; A01P 7/04

(52) U.S. Cl. 514/409

(57) ABSTRACT

Novel oil-based suspension concentrates consisting of
at least one compound, solid at room temperature, of the formula (I),
at least one penetrant,
at least one vegetable oil,
at least one nonionic surfactant and/or at least one anionic surfactant and
optionally one or more additives from the groups of the emulsifiers, the antifoams, the preservatives, the antioxidants, the colorants and/or the inert fillers,
   a process for preparing these suspension concentrates and their use for applying the active compounds comprised therein to plants and/or their habitat and for controlling insects.

The present invention relates to novel oil-based suspension concentrates of cyclic ketoenols of the formula (I), to a process for preparing these formulations and to their use for applying the cyclic ketoenols of the formula (I) comprised therein to plants and/or their habitat and for controlling insects.

It is already known that certain cyclic ketoenols have insecticidal and/or acaricidal properties (see, for example, WO 98/05638 and WO 04/007448). Numerous water-free suspension concentrates of agrochemically active compounds are likewise already known. Thus, EP-A 0 789 999 describes formulations of this type which, in addition to active compound and oil, comprise a mixture of various surfactants—including surfactants serving as penetrants—and also a hydrophobized sheet alumosilicate as thickener. The stability of these preparations is good. However, they have the disadvantage that a thickener is imperatively present, and this renders the preparation more complicated. Moreover, the thickener absorbs in each case part of the added amount of penetrant, which is then not available for its intended purpose.

WO 03/000053 describes formulations of this type which, in addition to active compound and oil, comprise a mixture of various surfactants—including surfactants serving as penetrants. The formulations described do not require a thickener for stabilization. In this publication, the synergistic effect of vegetable oils and penetrants is emphasized. These formulations have the advantage that their preparation is less complicated than the preparation of corresponding formulations comprising thickeners. However, cyclic ketoenols of the formula (I) are not mentioned.

WO 05/084441 describes formulations of this type which, in addition to certain cyclic ketoenols and oil, comprise a penetrant. Here, alkanolethoxylates are mentioned as particularly preferred penetrants. However, these formulations do not comprise a thickener.

The oil-based suspension concentrates of cyclic ketoenols described in WO 05/084441 have the disadvantage that these formulations have a very high viscosity, in particular at temperatures below 10° C. The advantage of the high viscosity of the oil-based suspension concentrates is the fact that owing to the high viscosity it is possible to avoid a sedimentation of the suspension particles in the concentrate. However, as a result of the large increase at low temperatures, the products, when used under such conditions, do not flow freely from the package. Furthermore, it is problematic to prepare the spray liquor using highly viscous formulations.

Accordingly, it is the object of the present invention to provide stable, storable oil-based suspension concentrates without the addition of thickeners, which concentrates, in general and in particular at temperatures below 10° C., have low viscosity and are thus easy to apply by the user.

This invention now provides novel oil-based suspension concentrates, comprising
at least one compound, solid at room temperature, of the formula (I)

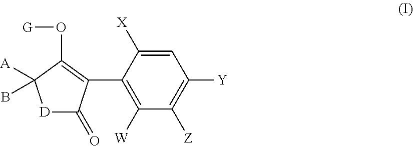

in which
X represents halogen, alkyl, alkoxy, haloalkyl, haloalkoxy or cyano,
W, Y and Z independently of one another represent hydrogen, halogen, alkyl, alkoxy, haloalkyl, haloalkoxy or cyano,
A represents hydrogen, in each case optionally halogen-substituted alkyl, alkoxyalkyl, saturated, optionally substituted cycloalkyl in which optionally at least one ring atom is replaced by a heteroatom,
B represents hydrogen or alkyl,
or
A and B together with the carbon atom to which they are attached represent a saturated or unsaturated, unsubstituted or substituted cycle which optionally contains at least one heteroatom,
D represents NH or oxygen,
G represents hydrogen (a) or represents one of the groups

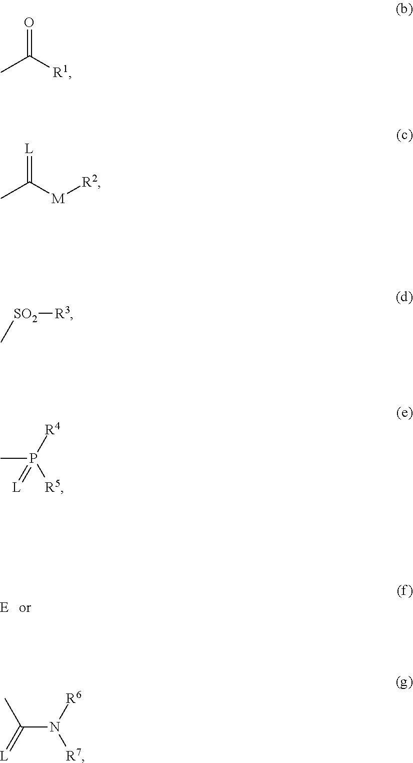

in which
E represents a metal ion or an ammonium ion,
L represents oxygen or sulphur,
M represents oxygen or sulphur,
R¹ represents in each case optionally halogen-substituted alkyl, alkenyl, alkoxyalkyl, alkylthioalkyl, polyalkoxyalkyl or optionally halogen-, alkyl- or alkoxy-substituted cycloalkyl which may be interrupted by at least one heteroatom, in each case optionally substituted phenyl, phenylalkyl, hetaryl, phenoxyalkyl or hetaryloxy-alkyl,
R² represents in each case optionally halogen-substituted alkyl, alkenyl, alkoxyalkyl, polyalkoxyalkyl or represents in each case optionally substituted cycloalkyl, phenyl or benzyl,
R³ represents optionally halogen-substituted alkyl or optionally substituted phenyl,
R⁴ and R⁵ independently of one another represent in each case optionally halogen-substituted alkyl, alkoxy, alkylamino, dialkylamino, alkylthio, alkenylthio, cyclo-alkylthio or represent in each case optionally substituted phenyl, benzyl, phenoxy or phenylthio and
R⁶ and R⁷ independently of one another represent hydrogen, in each case optionally halogen-substituted alkyl, cycloalkyl, alkenyl, alkoxy, alkoxyalkyl, represent optionally substituted phenyl, represent optionally substituted benzyl or together with the nitrogen atom to which they are attached represent an optionally substituted ring which is optionally interrupted by oxygen or sulphur
   in the form of their isomer mixtures or pure isomers,
at least one penetrant of the formula (II)

R⁸—O—(—PO-)_{q}-(-EO—)ₚ—R⁹ (II)
in which
R⁸ represents straight-chain or branched alkyl having 4 to 20 carbon atoms,
R⁹ represents H, methyl, ethyl, n-propyl, isopropyl, n-butyl, isobutyl, t-butyl, n-pentyl or n-hexyl,
EO represents CH₂—CH₂—O—,
PO represents

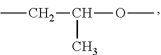

p represents a number from 4 to 8 and
q represents a number from 6 to 10,
at least one vegetable oil,
at least one nonionic surfactant selected from the group consisting of
   polyethylene oxide polypropylene oxide 4-butoxybutyl ether,
   polyethylene glycol ethers of straight-chain alcohols,
   products of the reaction of fatty acids with ethylene oxide and
   mixtures of these abovementioned surfactants and/or
at least one anionic surfactant and
optionally one or more additives from the groups of the emulsifiers, the spreaders, the antifoams, the preservatives, the antioxidants, the colorants and/or the inert fillers (materials which have no effect on the viscosity of the formulation).

Furthermore, it has been found that the oil-based suspension concentrates according to the invention can be prepared by mixing the ingredients stated above with one another and then optionally grinding the resulting suspension.

Finally, it has been found that the oil-based suspension concentrates according to the invention are highly suitable for applying the compounds of the formula (I) comprised therein to plants and/or their habitat.

Furthermore, it has been found that the oil-based suspension concentrates according to the invention are highly suitable for controlling insects.

It is extremely surprising that the oil-based suspension concentrates according to the invention have a considerably lower viscosity, in particular at temperatures below 10° C., compared to the prior-art formulations of the most similar composition. Based on the prior art described above, this effect was unforeseeable. Furthermore, it is very surprising that the biological activity of the oil-based suspension concentrates according to the invention is better than that of the prior-art formulations of the most similar composition. Finally, it is also surprising that the compatibility of the formulations with plants has been improved, although the uptake of the active compounds into the plant has been increased.

Preferred, particularly preferred, very particularly preferred, especially preferred and emphasized substituent definitions for compounds of the formula (I) are illustrated below:
W preferably represents hydrogen, C₁-C₄-alkyl, C₁-C₄-alkoxy, chlorine, bromine or fluorine,
X preferably represents C₁-C₄-alkyl, C₁-C₄-alkoxy, C₁-C₄-haloalkyl, fluorine, chlorine or bromine,
Y and Z independently of one another preferably represent hydrogen, C₁-C₄-alkyl, halogen, C₁-C₄-alkoxy or C₁-C₄-haloalkyl,
A preferably represents hydrogen or in each case optionally halogen-substituted C₁-C₆-alkyl or C₃-C₈-cycloalkyl,
B preferably represents hydrogen, methyl or ethyl,
A, B and the carbon atom to which they are attached preferably represent saturated C₃-C₆-cycloalkyl in which optionally one ring member is replaced by oxygen or sulphur and which is optionally mono- or disubstituted by C₁-C₄-alkyl, trifluoromethyl or C₁-C₄-alkoxy,
D preferably represents NH or oxygen,
G preferably represents hydrogen (a) or represents one of the groups

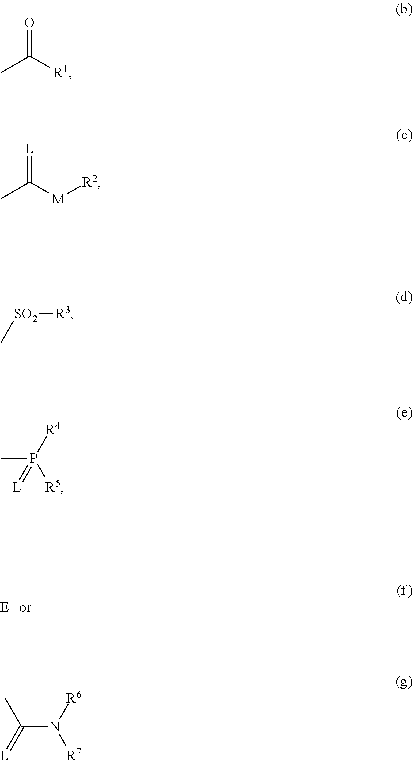

in particular (a), (b), (c) or (g)
in which
E represents a metal ion or an ammonium ion,
L represents oxygen or sulphur and
M represents oxygen or sulphur,
R¹ preferably represents in each case optionally halogen-substituted C₁-C₁₀-alkyl, C₂-C₁₀-alkenyl, C₁-C₄-alkoxy-C₁-C₄-alkyl, C₁-C₄-alkylthio-C₁-C₄-alkyl or optionally fluorine-, chlorine-, C₁-C₄-alkyl- or C₁-C₂-alkoxy-substituted C₃-C₆-cycloalkyl,
   represents optionally fluorine-, chlorine-, bromine-, cyano-, nitro-, C₁-C₄-alkyl-, C₁-C₄-alkoxy-, trifluoromethyl- or trifluoromethoxy-substituted phenyl,
   represents in each case optionally chlorine- or methyl-substituted pyridyl or thienyl,
R² preferably represents in each case optionally fluorine- or chlorine-substituted C₁-C₁₀-alkyl, C₁-C₁₀-alkenyl, C₁-C₄-alkoxy-C₁-C₄-alkyl,
   represents optionally methyl- or methoxy-substituted C₅-C₆-cycloalkyl or
   represents in each case optionally fluorine-, chlorine-, bromine-, cyano-, nitro-, C₁-C₄-alkyl-, C₁-C₄-alkoxy-, trifluoromethyl- or trifluoromethoxy-substituted phenyl or benzyl,
R³ preferably represents optionally fluorine-substituted C₁-C₄-alkyl or represents optionally fluorine-, chlorine-, bromine-, C₁-C₄-alkyl-, C₁-C₄-alkoxy-, trifluoromethyl-, trifluoromethoxy-, cyano- or nitro-substituted phenyl,
R⁴ preferably represents in each case optionally fluorine- or chlorine-substituted C₁-C₁-alkyl, C₁-C₄-alkoxy, C₁-C₄-alkylamino, C₁-C₄-alkylthio or represents in each case optionally fluorine-, chlorine-, bromine-, nitro-, cyano-, C₁-C₄-alkoxy-, trifluoromethoxy-, C₁-C₄-alkylthio-, C₁-C₄-haloalkylthio-, C₁-C₄-alkyl- or trifluoromethyl-substituted phenyl, phenoxy or phenylthio,
R⁵ preferably represents C₁-C₄-alkoxy or C₁-C₄-thioalkyl,
R⁶ preferably represents C₁-C₆-alkyl, C₃-C₆-cycloalkyl, C₁-C₆-alkoxy, C₃-C₆-alkenyl or C₁-C₄-alkoxy-C₁-C₄-alkyl,
R⁷ preferably represents C₁-C₆-alkyl, C₃-C₆-alkenyl or C₁-C₄-alkoxy-C₁-C₄-alkyl,
R⁶ and R⁷ together preferably represent an optionally methyl- or ethyl-substituted C₃-C₆-alkylene radical in which optionally one carbon atom is replaced by oxygen or sulphur,
   in the form of their isomer mixtures or pure isomers.
W particularly preferably represents hydrogen, methyl, ethyl, chlorine, bromine or methoxy,
X particularly preferably represents chlorine, bromine, methyl, ethyl, propyl, isopropyl, methoxy, ethoxy or trifluoromethyl,
Y and Z independently of one another particularly preferably represent hydrogen, fluorine, chlorine, bromine, methyl, ethyl, propyl, isopropyl, trifluoromethyl or methoxy,
A particularly preferably represents methyl, ethyl, propyl, isopropyl, butyl, isobutyl, sec.-butyl, tert.-butyl, cyclopropyl, cyclopentyl or cyclohexyl,
B particularly preferably represents hydrogen, methyl or ethyl,
   or
A, B and the carbon atom to which they are attached particularly preferably represent saturated C₅-C₆-cycloalkyl in which optionally one ring member is replaced by oxygen and which is optionally monosubstituted by methyl, ethyl, trifluoromethyl, methoxy, ethoxy, propoxy or butoxy,
D particularly preferably represents NH or oxygen,
G particularly preferably represents hydrogen (a) or represents one of the groups

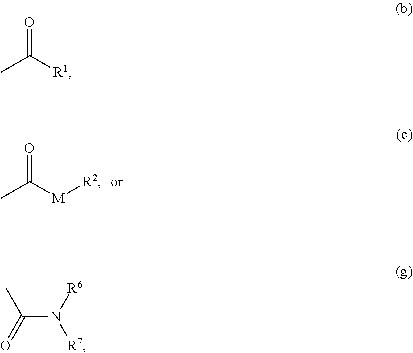

in welchen
M represents oxygen or sulphur,
R¹ particularly preferably represents C₁-C₈-alkyl, C₂-C₄-alkenyl, methoxymethyl, ethoxy-methyl, ethylthiomethyl, cyclopropyl, cyclopentyl or cyclohexyl,
   represents phenyl which is optionally mono- or disubstituted by fluorine, chlorine, bromine, cyano, nitro, methyl, ethyl, methoxy, trifluoromethyl or trifluoromethoxy,
   represents in each case optionally chlorine- or methyl-substituted pyridyl or thienyl,
R² particularly preferably represents C₁-C₈-alkyl, C₂-C₄-alkenyl, methoxyethyl, ethoxyethyl or represents phenyl or benzyl,
R⁶ and R⁷ independently of one another particularly preferably represent methyl, ethyl or together represent a C₅-alkylene radical in which the C₃-methylene group is replaced by oxygen,
   in the form of their isomer mixtures or pure isomers.
W very particularly preferably represents hydrogen or methyl,
X very particularly preferably represents chlorine, bromine or methyl,
Y and Z independently of one another very particularly preferably represent hydrogen, chlorine, bromine or methyl,
A, B and the carbon atom to which they are attached very particularly preferably represent saturated C₅-C₆-cycloalkyl in which optionally one ring member is replaced by oxygen and which is optionally monosubstituted by methyl, trifluoromethyl, methoxy, ethoxy, propoxy or butoxy,
D very particularly preferably represents NH or oxygen,
G very particularly preferably represents hydrogen (a) or represents one of the groups

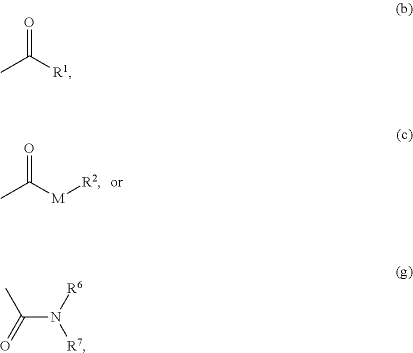

in which
M represents oxygen or sulphur,
R¹ particularly preferably represents C₁-C₈-alkyl, C₂-C₄-alkenyl, methoxymethyl, ethoxy-methyl, ethylthiomethyl, cyclopropyl, cyclopentyl, cyclohexyl or
   represents phenyl which is optionally monosubstituted by fluorine, chlorine, bromine, methyl, methoxy, trifluoromethyl, trifluoromethoxy, cyano or nitro,
   represents in each case optionally chlorine- or methyl-substituted pyridyl or thienyl,
R² very particularly preferably represents C₁-C₈-alkyl, C₂-C₄-alkenyl, methoxyethyl, ethoxy-ethyl, phenyl or benzyl,
R⁶ and R⁷ independently of one another very particularly preferably represent methyl, ethyl or together represent a C₅-alkylene radical in which the C₃-methylene group is replaced by oxygen,
   in the form of their isomer mixtures or pure isomers.

Special preference is given to suspension concentrates comprising compounds of the formula (I) from the following patents/patent applications cited on page 1 in which the radicals A, B, D, G, W, X, Y, Z, R¹, R², R⁶ and R⁷ have the meaning mentioned in the very particularly preferred ranges: WO 98/05638, WO 04/007448.

From these applications, emphasis is given to using the following compounds of the formula (I)

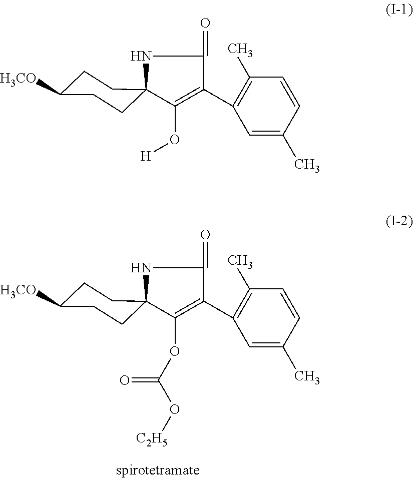

for suspension concentrates according to the invention.

Suitable penetrants in the present context are certain substances which are customarily used to improve penetration of agrochemically active compounds into plants. In the present context, penetrants are defined in that they penetrate from the aqueous spray liquor and/or from the spray coating into the cuticle of the plant, thus being able to increase the mobility of active compounds in the cuticle. The method described below and in the literature (Baur et al., 1997, Pesticide Science 51, 131-152) can be used to assess this property.

Suitable are alkanol alkoxylates of the formula (II)

R⁸—O—(—PO-)q-(-EO-)p-R⁹ (II)

in which
R⁸ represents straight-chain or branched alkyl having 4 to 20 carbon atoms,
R⁹ represents H, methyl, ethyl, n-propyl, isopropyl, n-butyl, isobutyl, t-butyl, n-pentyl or n-hexyl,
EO represents CH₂—CH₂—O—,
PO represents

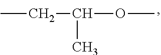

p represents a number from 4 to 8 and
q represents a number from 6 to 10.

In the formulae given above
R⁸ preferably represents butyl, isobutyl, n-pentyl, isopentyl, neopentyl, n-hexyl, isohexyl, n-octyl, isooctyl, 2-ethylhexyl, nonyl, isononyl, decyl, n-dodecyl, isododecyl, lauryl, myristyl, isotridecyl, trimethylnonyl, palmityl, stearyl or eicosyl and
   particularly preferably represents n-hexyl, isohexyl, n-octyl, isooctyl, 2-ethylhexyl, nonyl, isononyl or decyl and
   very particularly preferably represents 2-ethylhexyl.

In the formulae given above
R⁹ preferably represents H, methyl, ethyl, n-propyl or isopropyl and
   particularly preferably represents H.

In the formulae given above
p preferably represents 5 to 7, very particularly preferably 6 and
q preferably represents 7 to 9, very particularly preferably represents 8.

Preferably suitable are alkanol alkoxylates of the formula (II)

R⁸—O—(—PO-)_{q}-(-EO—)ₚ—R⁹ (II)

in which
R⁸ represents butyl, isobutyl, n-pentyl, isopentyl, neopentyl, n-hexyl, isohexyl, n-octyl, isooctyl, 2-ethylhexyl, nonyl, isononyl, decyl, n-dodecyl, isododecyl, lauryl, myristyl, isotridecyl, trimethylnonyl, palmityl, stearyl or eicosyl,
R⁹ represents H, methyl, ethyl, n-propyl or isopropyl,
EO represents CH₂—CH₂—O—,
PO represents

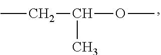

p represents a number from 5 to 7 and
q represents a number from 7 to 9.

Furthermore preferably suitable are alkanol alkoxylates of the formula (II)

R⁸—O—(—PO-)q-(-EO-)p-R⁹ (II)

in which
R⁸ represents n-hexyl, isohexyl, n-octyl, isooctyl, 2-ethylhexyl, nonyl, isononyl or decyl,
R⁹ represents H,
EO represents CH₂—CH₂—O—,
PO represents

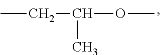

p represents a number from 5 to 7 and
q represents a number from 7 to 9.

Furthermore preferably suitable are alkanol alkoxylates of the formula (II)

R⁸—O—(—PO-)q-(-EO-)p-R⁹ (II)

in which
R⁸ represents n-hexyl, isohexyl, n-octyl, isooctyl, 2-ethylhexyl, nonyl, isononyl or decyl,
R⁹ represents H,
EO represents CH₂—CH₂—O—,
PO represents

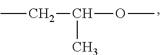

p represents 6 and
represents 8.

An emphasized example of an alkanol alkoxylate of the formula (II) which may be mentioned is 2-ethylhexyl alkoxylate of the formula (II-1),

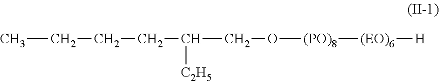

in which EO and PO have the meanings given above and the numbers 8 and 6 are average values.

The above formulae provide general definitions of the alkanol alkoxylates. These substances are mixture of compounds of the stated type having various chain lengths. The values calculated for the indices are therefore average values which may also differ from integers.

The alkanol alkoxylates of the stated formulae are known and commercially available or can be prepared by known methods.

Suitable vegetable oils are all oils which are obtainable from plants and which are customarily used in agrochemical compositions. These are vegetable oils which are liquid at room temperature. Examples which may be mentioned are sunflower oil, rapeseed oil, maize oil, olive oil and soyabean oil. Cottonseed oil, colza oil, coconut oil, peanut oil, almond oil, sesame oil, walnut oil and hemp oil may also be mentioned.

The following oils may be mentioned as being preferred: rapeseed oil, maize oil, soyabean oil and sunflower oil.

Very particular preference is given to the following oils: maize oil, soyabean oil and sunflower oil. Sunflower oil is especially preferred.

The oil-based suspension concentrates according to the invention comprise at least one nonionic surfactant and/or at least one anionic surfactant.

Suitable nonionic surfactants are polyethylene oxide polypropylene oxide 4-butoxybutyl ether, polyethylene glycol ethers of straight-chain alcohols, products of the reaction of fatty acids with ethylene oxide and mixtures of these surfactants. Preferably, the compositions according to the invention comprise a mixture of 5- to 9-fold polyethoxylated (C₁₂₋₁₅) fatty alcohol and a propoxylated and ethoxylated 4-butoxybutyl alcohol and at least a further one of the nonionic surfactants mentioned.

Suitable anionic surfactants are salts, sparingly soluble in vegetable oil, of polystyrenesulphonic acids, salts of polyvinylsulphonic acids, salts of naphthalenesulphonic acid/formaldehyde conden-sates, salts of condensates of naphthalenesulphonic acid, phenolsulphonic acid and formaldehyde and also salts of lignosulphonic acid. Preference is given to salts of naphthalenesulphonic acid/formaldehyde condensates.

Suitable additives which may be present in the formulations according to the invention are emulsifiers, spreaders, antifoams, preservatives, antioxidants, colorants and inert fillers.

Preferred emulsifiers are ethoxylated nonylphenols, products of the reaction of alkylphenols with ethylene oxide and/or propylene oxide, ethoxylated arylalkylphenols, furthermore ethoxylated and propoxylated arylalkylphenols, and also sulphated or phosphated arylalkyl ethoxylates or arylalkyl ethoxypropoxylates, and sorbitan derivatives, polyethylene oxide sorbitan fatty esters and sorbitan fatty esters may be mentioned by way of example. Polyoxyethylene sorbitol oleate may be mentioned as being preferred.

Suitable spreaders are all substances which are customarily used for this purpose in agrochemical compositions. Preference is given to alkylsiloxanes.

Suitable antifoams are all substances which are customarily used for this purpose in agrochemical compositions. Preference is given to silicone oils and magnesium stearate.

Suitable preservatives are all substances which are customarily used for this purpose in agrochemical compositions of this type. Examples which may be mentioned are Preventol® (from Bayer AG) and Proxel®.

Suitable antioxidants are all substances which are customarily used for this purpose in agrochemical compositions. Preference is given to 2,6-di-tert-butyl-4-methylphenol.

Suitable colorants are all substances which are customarily used for this purpose in agrochemical compositions. Examples which may be mentioned are titanium dioxide, pigmentary carbon black, zinc oxide and blue pigments and also Permanent Red FGR.

Suitable inert fillers are all substances which are customarily used for this purpose in agrochemical compositions and which do not act as thickeners. Preference is given to inorganic particles such as carbonates, silicates and oxides, and also to organic substances such as urea formaldehyde condensates. Examples which may be mentioned are kaolin, rutile, silicon dioxide, what is known as finely divided silicic acid, silica gels, and also natural and synthetic silicates, moreover talc.

The content of the individual components in the oil-based suspension concentrates according to the invention may be varied within a relatively wide range. Thus, the concentrations
of the compound of the formula (I) are generally from 5 to 30% by weight, preferably from 10 to 25% by weight, particularly preferably from 10 to 20% by weight, very particularly preferably from 10 to 18% by weight, furthermore from 5 to 12% by weight,
of penetrant are generally from 5 to 30% by weight, preferably from 15 to 25% by weight, particularly preferably from 17 to 22% by weight,
of vegetable oil are generally from 20 to 55% by weight, preferably from 25 to 52% by weight, particularly preferably from 25 to 50% by weight,
of surfactants are generally from 1 to 25% by weight, preferably from 1.0 to 15% by weight, very preferably from 1.5 to 5% by weight and
of additives are generally from 0 to 25% by weight, preferably from 0 to 20% by weight.

The oil-based suspension concentrates according to the invention are prepared by mixing the components in the respective desired ratios with one another. The components can be mixed with one another in any order. Expediently, the solid components are employed in a finely grounded state. However, it is also possible to subject the suspension formed on mixing the components initially to coarse grinding and then to fine grinding, so that the mean particle size is below 20 μm. Preference is given to suspension concentrates in which the solid particles have a mean particle size between 1 and 10 μm.

When carrying out the process according to the invention, the temperatures can be varied within a certain range. In general, the process is carried out at temperatures of from 10° C. to 60° C., preferably from 15° C. to 40° C. To carry out the process according to the invention, customary mixers and grinders used for preparing agrochemical formulations are employed.

The oil-based suspension concentrates according to the invention are formulations which remain stable even after prolonged storage at elevated temperatures or in the cold, since no crystal growth is observed. By dilution with water, they can be converted into homogeneous spray liquors. These spray liquors are applied by customary methods, i.e. for example by spraying, by watering or by injection.

The application rate of the oil-based suspension concentrates according to the invention can be varied within a relatively wide range. It depends on the respective agrochemically active compounds and their content in the compositions.

The compositions according to the invention, in combination with good plant tolerance and favourable toxicity to warm-blooded animals and being tolerated well by the environment, are suitable for protecting plants and plant organs, for increasing the harvest yields, for improving the quality of the harvested material and for controlling animal pests, in particular insects, arachnids, helminths, nematodes and molluscs, which are encountered in agriculture, in horticulture, in animal husbandry, in forests, in gardens and leisure facilities, in the protection of stored products and of materials, and in the hygiene sector. They may be preferably employed as plant protection agents. They are active against normally sensitive and resistant species and against all or some stages of development. The abovementioned pests include:

From the order of the Anoplura (Phthiraptera), for example, Damalinia spp., Haematopinus spp., Linognathus spp., Pediculus spp., Trichodectes spp. From the class of the Arachnida, for example, Acarus siro, Aceria sheldoni, Aculops spp., Aculus spp., Amblyomma spp., Argas spp., Boophilus spp., Brevipalpus spp., Bryobia praetiosa, Chorioptes spp., Dermanyssus gallinae, Eotetranychus spp., Epitrimerus pyri, Eutetranychus spp., Eriophyes spp., Hemitarsonemus spp., Hyalomma spp., Ixodes spp., Latrodectus mactans, Metatetranychus spp., Oligonychus spp., Ornithodoros spp., Panonychus spp., Phyllocoptruta oleivora, Polyphagotarsonemus latus, Psoroptes spp., Rhipicephalus spp., Rhizoglyphus spp., Sarcoptes spp., Scorpio maurus, Stenotarsonemus spp., Tarsonemus spp., Tetranychus spp., Vasates lycopersici.

From the class of the Bivalva, for example, Dreissena spp.

From the order of the Chilopoda, for example, Geophilus spp., Scutigera spp.

From the order of the Coleoptera, for example, Acanthoscelides obtectus, Adoretus spp., Agelastica alni, Agriotes spp., Amphimallon solstitialis, Anobium punctatum, Anoplophora spp., Anthonomus spp., Anthrenus spp., Apogonia spp., Atomaria spp., Attagenus spp., Bruchidius obtectus, Bruchus spp., Ceuthorhynchus spp., Cleonus mendicus, Conoderus spp., Cosmopolites spp., Costelytra zealandica, Curculio spp., Cryptorhynchus lapathi, Dermestes spp., Diabrotica spp., Epilachna spp., Faustinus cubae, Gibbium psylloides, Heteronychus arator, Hylamorpha elegans, Hylotrupes bajulus, Hypera postica, Hypothenemus spp., Lachnosterna consanguinea, Leptinotarsa decemlineata, Lissorhoptrus oryzophilus, Lixus spp., Lyctus spp., Meligethes aeneus, Melolontha melolontha, Migdolus spp., Monochamus spp., Naupactus xanthographus, Niptus hololeucus, Oryctes rhinoceros, Oryzaephilus surinamensis, Otiorrhynchus sulcatus, Oxycetonia jucunda, Phaedon cochleariae, Phyllophaga spp., Popillia japonica, Premnotrypes spp., Psylliodes chrysocephala, Ptinus spp., Rhizobius ventralis, Rhizopertha dominica, Sitophilus spp., Sphenophorus spp., Sternechus spp., Symphyletes spp., Tenebrio molitor, Tribolium spp., Trogoderma spp., Tychius spp., Xylotrechus spp., Zabrus spp.

From the order of the Collembola, for example, Onychiurus armatus.

From the order of the Dermaptera, for example, Forficula auricularia.

From the order of the Diplopoda, for example, Blaniulus guttulatus.

From the order of the Diptera, for example, Aedes spp., Anopheles spp., Bibio hortulanus, Calliphora erythrocephala, Ceratitis capitata, Chrysomyia spp., Cochliomyia spp., Cordylobia anthropophaga, Culex spp., Cuterebra spp., Dacus oleae, Dermatobia hominis, Drosophila spp., Fannia spp., Gastrophilus spp., Hylemyia spp., Hyppobosca spp., Hypoderma spp., Liriomyza spp., Lucilia spp., Musca spp., Nezara spp., Oestrus spp., Oscinella frit, Pegomyia hyoscyami, Phorbia spp., Stomoxys spp., Tabanus spp., Tannia spp., Tipula paludosa, Wohlfahrtia spp.

From the class of the Gastropoda, for example, Anion spp., Biomphalaria spp., Bulinus spp., Deroceras spp., Galba spp., Lymnaea spp., Oncomelania spp., Succinea spp.

From the class of the helminths, for example, Ancylostoma duodenale, Ancylostoma ceylanicum, Acylostoma braziliensis, Ancylostoma spp., Ascaris lubricoides, Ascaris spp., Brugia malayi, Brugia timori, Bunostomum spp., Chabertia spp., Clonorchis spp., Cooperia spp., Dicrocoelium spp., Dictyocaulus filaria, Diphyllobothrium latum, Dracunculus medinensis, Echinococcus granulosus, Echinococcus multilocularis, Enterobius vermicularis, Faciola spp., Haemonchus spp., Heterakis spp., Hymenolepis nana, Hyostrongulus spp., Loa Loa, Nematodirus spp., Oesophagostomum spp., Opisthorchis spp., Onchocerca volvulus, Ostertagia spp., Paragonimus spp., Schistosomen spp., Strongyloides fuelleborni, Strongyloides stercoralis, Stronyloides spp., Taenia saginata, Taenia solium, Trichinella spiralis, Trichinella nativa, Trichinella britovi, Trichinella nelsoni, Trichinella pseudopsiralis, Trichostrongulus spp., Trichuris trichuria, Wuchereria bancrofti.

It is furthermore possible to control protozoa, such as Eimeria.

From the order of the Heteroptera, for example, Anasa tristis, Antestiopsis spp., Blissus spp., Calocoris spp., Campylomma livida, Cavelerius spp., Cimex spp., Creontiades dilutus, Dasynus piperis, Dichelops furcatus, Diconocoris hewetti, Dysdercus spp., Euschistus spp., Eurygaster spp., Heliopeltis spp., Horcias nobilellus, Leptocorisa spp., Leptoglossus phyllopus, Lygus spp., Macropes excavatus, Miridae, Nezara spp., Oebalus spp., Pentomidae, Piesma quadrata, Piezodorus spp., Psallus seriatus, Pseudacysta persea, Rhodnius spp., Sahlbergella singularis, Scotinophora spp., Stephanitis nashi, Tibraca spp., Triatoma spp.

From the order of the Homoptera, for example, Acyrthosipon spp., Aeneolamia spp., Agonoscena spp., Aleurodes spp., Aleurolobus barodensis, Aleurothrixus spp., Amrasca spp., Anuraphis cardui, Aonidiella spp., Aphanostigma pini, Aphis spp., Arboridia apicalis, Aspidiella spp., Aspidiotus spp., Atanus spp., Aulacorthum solani, Bemisia spp., Brachycaudus helichrysii, Brachycolus spp., Brevicoryne brassicae, Calligypona marginata, Carneocephala fulgida, Ceratovacuna lanigera, Cercopidae, Ceroplastes spp., Chaetosiphon fragaefolii, Chionaspis tegalensis, Chlorita onukii, Chromaphis juglandicola, Chrysomphalus ficus, Cicadulina mbila, Coccomytilus halli, Coccus spp., Cryptomyzus ribis, Dalbulus spp., Dialeurodes spp., Diaphorina spp., Diaspis spp., Doralis spp., Drosicha spp., Dysaphis spp., Dysmicoccus spp., Empoasca spp., Eriosoma spp., Erythroneura spp., Euscelis bilobatus, Geococcus coffeae, Homalodisca coagulata, Hyalopterus arundinis, Icerya spp., Idiocerus spp., Idioscopus spp., Laodelphax striatellus, Lecanium spp., Lepidosaphes spp., Lipaphis erysimi, Macrosiphum spp., Mahanarva fimbriolata, Melanaphis sacchari, Metcalfiella spp., Metopolophium dirhodum, Monellia costalis, Monelliopsis pecanis, Myzus spp., Nasonovia ribisnigri, Nephotettix spp., Nilaparvata lugens, Oncometopia spp., Orthezia praelonga, Parabemisia myricae, Paratrioza spp., Parlatoria spp., Pemphigus spp., Peregrinus maidis, Phenacoccus spp., Phloeomyzus passerinii, Phorodon humuli, Phylloxera spp., Pinnaspis aspidistrae, Planococcus spp., Protopulvinaria pyriformis, Pseudaulacaspis pentagona, Pseudococcus spp., Psylla spp., Pteromalus spp., Pyrilla spp., Quadraspidiotus spp., Quesada gigas, Rastrococcus spp., Rhopalosiphum spp., Saissetia spp., Scaphoides titanus, Schizaphis graminum, Selenaspidus articulatus, Sogata spp., Sogatella furcifera, Sogatodes spp., Stictocephala festina, Tenalaphara malayensis, Tinocallis caryaefoliae, Tomaspis spp., Toxoptera spp., Trialeurodes vaporariorum, Trioza spp., Typhlocyba spp., Unaspis spp., Viteus vitifolii.

From the order of the Hymenoptera, for example, Diprion spp., Hoplocampa spp., Lasius spp., Monomorium pharaonis, Vespa spp.

From the order of the Isopoda, for example, Armadillidium vulgare, Oniscus asellus, Porcellio scaber.

From the order of the Isoptera, for example, Reticuliteimes spp., Odontotermes spp.

From the order of the Lepidoptera, for example, Acronicta major, Aedia leucomelas, Agrotis spp., Alabama argillacea, Anticarsia spp., Barathra brassicae, Bucculatrix thurberiella, Bupalus piniarius, Cacoecia podana, Capua reticulana, Carpocapsa pomonella, Chematobia brumata, Chilo spp., Choristoneura fumiferana, Clysia ambiguella, Cnaphalocerus spp., Earias insulana, Ephestia kuehniella, Euproctis chrysorrhoea, Euxoa spp., Feltia spp., Galleria mellonella, Helicoverpa spp., Heliothis spp., Hofmannophila pseudospretella, Homona magnanima, Hyponomeuta padella, Laphygma spp., Lithocolletis blancardella, Lithophane antennata, Loxagrotis albicosta, Lymantria spp., Malacosoma neustria, Mamestra brassicae, Mocis repanda, Mythimna separata, Oria spp., Oulema oryzae, Panolis flammea, Pectinophora gossypiella, Phyllocnistis citrella, Pieris spp., Plutella xylostella, Prodenia spp., Pseudaletia spp., Pseudoplusia includens, Pyrausta nubilalis, Spodoptera spp., Thermesia gemmatalis, Tinea pellionella, Tineola bisselliella, Tortrix viridana, Trichoplusia spp.

From the order of the Orthoptera, for example, Acheta domesticus, Blatta orientalis, Blattella germanica, Gryllotalpa spp., Leucophaea maderae, Locusta spp., Melanoplus spp., Periplaneta americana, Schistocerca gregaria.

From the order of the Siphonaptera, for example, Ceratophyllus spp., Xenopsylla cheopis.

From the order of the Symphyla, for example, Scutigerella immaculata.

From the order of the Thysanoptera, for example, Baliothrips biformis, Enneothrips flavens, Frankliniella spp., Heliothrips spp., Hercinothrips femoralis, Kakothrips spp., Rhipiphorothrips cruentatus, Scirtothrips spp., Taeniothrips cardamoni, Thrips spp.

From the order of the Thysanura, for example, Lepisma saccharina.

The phytoparasitic nematodes include, for example, Anguina spp., Aphelenchoides spp., Belonoaimus spp., Bursaphelenchus spp., Ditylenchus dipsaci, Globodera spp., Heliocotylenchus spp., Heterodera spp., Longidorus spp., Meloidogyne spp., Pratylenchus spp., Radopholus similis, Rotylenchus spp., Trichodorus spp., Tylenchorhynchus spp., Tylenchulus spp., Tylenchulus semipenetrans, Xiphinema spp.

The compositions according to the invention are suitable for controlling animal pests, in particular sucking insects, such as, for example, Thrips spp., Aphids spp., Psylla spp., Skales spp., whiteflies.

In addition to the agrochemically active compounds already mentioned above, the compositions according to the invention may comprise, as mixing partners, further active compounds, such as insecticides, attractants, sterilants, bactericides, acaricides, nematicides, fungicides, growth regulators, herbicides, safeners, fertilizers or semiochemicals.

The active compounds referred to in the present specification by their “common name” are known, for example, from “The Pesticide Manual” 13th Ed., British Crop Protection Council 2003, and the website http://www.alanwood.net/pesticides/.

acetylcholinesterase (AChE) inhibitors II-1
II-1.A carbamates,
   for example alanycarb (II-1.A-1), aldicarb (II-1.A-2), aldoxycarb (II-1.A-3), allyxycarb (II-1.A-4), aminocarb (II-1.A-5), bendiocarb (II-1.A-6), benfuracarb (II-1.A-7), bufencarb (II-1.A-8), butacarb (II-1.A-9), butocarboxim (II-1.A-10), butoxycarboxim (II-1.A-11), carbaryl (II-1.A-12), carbofuran (II-1.A-13), carbosulfan (II-1.A-14), cloethocarb (II-1.A-15), dimetilan (II-1.A-16), ethiofencarb (II-1.A-17), fenobucarb (II-1.A-18), fenothiocarb (II-1.A-19), formetanate (II-1.A-20), furathiocarb (II-1.A-21), isoprocarb (II-1.A-22), metam-sodium (II-1.A-23), methiocarb (II-1.A-24), methomyl (II-1.A-25), metolcarb (II-1.A-26), oxamyl (II-1.A-27), pirimicarb (II-1.A-28), promecarb (II-1.A-29), propoxur (II-1.A-30), thiodicarb (II-1.A-31), thiofanox (II-1.A-32), trimethacarb (II-1.A-33), XMC (II-1.A-34), xylylcarb (II-1.A-35)
      antagonists of GABA-gated chloride channels II-2
II-2B fiproles (phenylpyrazoles),
   for example acetoprole (II-2B-1), ethiprole (II-2B-2), fipronil (II-2B-3), pyrafluprole (II-2B-4), pyriprole (II-2B-5), vaniliprole (II-2B-6)
      sodium channel modulators/blockers of voltage-gated sodium channels II-3
II-3 pyrethroids,
   for example acrinathrin (II-3-1), allethrin (d-cis-trans, d-trans) (II-3-2), beta-cyfluthrin (II-3-3), bifenthrin (II-3-4), bioallethrin (II-3-5), bioallethrin S-cyclopentyl isomer (II-3-6), bioethanomethrin (II-3-7), biopermethrin (II-3-8), bioresmethrin (II-3-9), chlovaporthrin (II-3-10), cis-cypermethrin (II-3-11), cis-resmethrin (II-3-12), cis-permethrin (II-3-13), clocythrin (II-3-14), cycloprothrin (II-3-15), cyfluthrin (II-3-16), cyhalothrin (II-3-17), cypermethrin (alpha-, beta-, theta-, zeta-) (II-3-18), cyphenothrin (II-3-19), deltamethrin (II-3-20), empenthrin (1R isomer) (II-3-21), esfenvalerate (II-3-22), etofenprox (II-3-23), fenfluthrin (II-3-24), fenpropathrin (II-3-25), fenpyrithrin (II-3-26), fenvalerate (II-3-27), flubrocythrinate (II-3-28), flucythrinate (II-3-29), flufenprox (II-3-30), flumethrin (II-3-31), fluvalinate (II-3-32), fubfenprox (II-3-33), gamma-cyhalothrin (II-3-34), imiprothrin (II-3-35), kadethrin (II-3-36), lambda-cyhalothrin (II-3-37), metofluthrin (II-3-38), permethrin (cis-, trans-) (II-3-39), phenothrin (1R-trans isomer) (II-3-40), prallethrin (II-3-41), profluthrin (II-3-42), protrifenbute (II-3-43), pyresmethrin (II-3-44), resmethrin (II-3-45), RU 15525 (II-3-46), silafluofen (II-3-47), tau-fluvalinate (II-3-48), tefluthrin (II-3-49), terallethrin (II-3-50), tetramethrin (-1R isomer) (II-3-51), tralomethrin (II-3-52), transfluthrin (II-3-53), ZXI 8901 (II-3-54), pyrethrin (pyrethrum) (II-3-55), eflusilanate (II-3-56),
   DDT (II-3-57),
   methoxychlor (II-3-58),
      agonists/antagonists of the nicotinergic acetylcholine receptor II-4
II-4A chloronicotinyls,
   for example acetamiprid (II-4A-1), clothianidin (II-4A-2), dinotefuran (II-4A-3), imidacloprid (II-4A-4), imidaclothiz (II-4A-5), nitenpyram (II-4A-6), nithiazine (II-4A-7), thiacloprid (II-4A-8), thiamethoxam (II-4A-9),

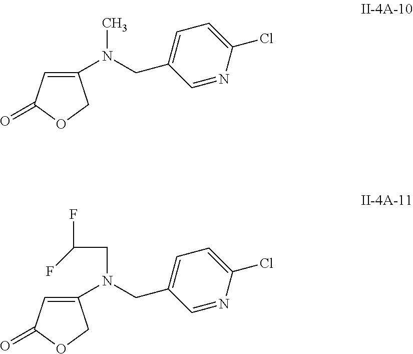

II-4B nicotine (II-4B-1), bensultap (II-4B-2), cartap (II-4B-3), thiosulfap-sodium (II-4B-4), thiocylam (II-4C-4)
   allosteric modulators of the acetylcholine receptor (agonists)
II-5 spinosyns,
   for example spinosad (II-5-1), spinetoram (II-5-2)
      Chloride channel activators
II-6 mectins/macrolides,
   for example abamectin (II-6-1), emamectin (II-6-2), emamectin-benzoate (II-6-3), ivermectin (II-6-4), lepimectin (II-6-5), milbemectin (II-6-6)
II-7A juvenile hormone analogues,
   for example hydroprene (II-7A-1), kinoprene (II-7A-2), methoprene (II-7A-3), epofenonane (II-7A-4), triprene (II-7A-5), fenoxycarb (II-7B-1),
   pyriproxifen (II-7C-1), diofenolan (II-7C-2)
      active compounds having unknown or non-specific mechanisms of action
II-8 fumigants,
   for example methylbromide (II-8A-1), chloropicrin (II-8B-1), sulfuryl fluoride (II-8C-1)
II-9 selective antifeedants,
   for example cryolite (II-9A-1), pymetrozine (II-9B-1), pyrifluquinazone (NNI0101) (II-9B-2), flonicamid (II-9C-1)
II-10 mite growth inhibitors,
   for example clofentezine (II-10A-1), hexythiazox (II-10A-2), etoxazole (II-10B-1),
      inhibitors of oxidative phosphorylation, ATP disruptors II-12
II-12A diafenthiuron (II-12A-1)
II-12B organotin compounds,
   for example azocyclotin (II-12B-1), cyhexatin (II-12B-2), fenbutatin oxide (II-12B-3)
II-12C propargite (II-12C-1), tetradifon (II-12C-2)
   decouplers of oxidative phosphorylation by interruption of the H-proton gradient II-13
   clorfenapyr (II-13-1)
   binapacyrl (II-13-2), dinobuton (II-13-3), dinocap (II-13-4), DNOC (II-13-5)
   microbial disruptors of the insect gut membrane
   Bacillus thuringiensis strains (II-13-6)
   inhibitors of chitin biosynthesis
II-15 benzoylureas,
   for example bistrifluoron (II-15-1), chlorfluazuron (II-15-2), diflubenzuron (II-15-3), fluazuron (II-15-4), flucycloxuron (II-15-5), flufenoxuron (II-15-6), hexaflumuron (II-15-7), lufenuron (II-15-8), novaluron (II-15-9), noviflumuron (II-15-10), penfluoron (II-15-11), teflubenzuron (II-15-12), triflumuron (II-15-13)
II-16 buprofezin (II-16-1)
   moulting disruptors cyromazine (II-17-1)
   ecdysone agonists/disruptors (II-18)
II-18A diacylhydrazines
   for example chromafenozide (II-18A-1), halofenozide (II-18A-2), methoxyfenozide (II-18A-3), tebufenozide (II-18A-4), JS-118 (II-18A-5)
   azadirachtin (II-18B-1)
      octopaminergic agonists
   for example amitraz (II-19-1)
II-20 Site III Electron Transport Inhibitors/Site II Electron Transport Inhibitors
   hydramethylnon (II-20A-1)
   acequinocyl (II-20B-1)
   fluacrypyrim (II-20C-1)
   cyflumetofen (II-20D-1), cyenopyrafen (II-20D-2)
      electron transport inhibitors
II-21 site I electron transport inhibitors
   from the group of the METI acaricides,
   for example fenazaquin (II-21-1), fenpyroximate (II-21-2), pyrimidifen (II-21-3), pyridaben (II-21-4), tebufenpyrad (II-21-5), tolfenpyrad (II-21-6), rotenone (II-21-7)
II-22 blockers of voltage-gated sodium channels
   for example indoxacarb (II-22A-1)
   for example metaflumizone (BAS 3201) (II-22B-1)
II-23 inhibitors of fatty acid biosynthesis
II-23A Tetronic Acid Derivatives
   for example spirodiclofen (II-23A-1), spiromesifen (II-23A-2)
II-23B tetramic acid derivatives,
   for example spirotetramat (II-23B-1)
II-25 neuronal inhibitors having an unknown mechanism of action
   bifenazate (II-25-1)
      ryanodine receptor effectors
II-28 diamides,
   for example flubendiamide (II-28-1),

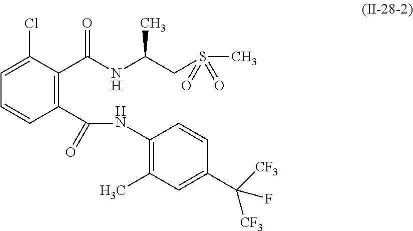

### Rynaxapyr (II-28-3), HGW86

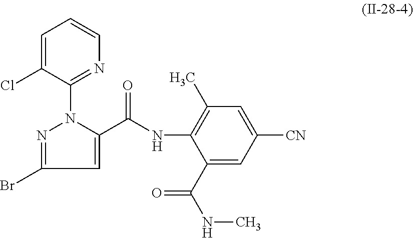

### Cyazypyr

II-29 active compounds having an unknown mechanism of action
   amidoflumet (II-29-1), benclothiaz (II-29-2), benzoximate (II-29-3), bromopropylate (II-29-4), buprofezin (II-29-5), chinomethionat (II-29-6), chlordimeform (II-29-7), chlorobenzilate (II-29-8), clothiazoben (II-29-9), cycloprene (II-29-10), dicofol (II-29-11), dicyclanil (II-29-12), fenoxacrim (II-29-13), fentrifanil (II-29-14), flubenzimine (II-29-15), flufenerim (II-29-16), flutenzin (II-29-17), gossyplure (II-29-18), japonilure (II-29-19), metoxadiazone (II-29-20), petroleum (II-29-21), potassium oleate (II-29-22), pyridalyl (II-29-23), sulfluramid (II-29-24), tetrasul (II-29-25), triarathene (II-29-26), verbutin (II-29-27).

Preferably, the suspension concentrate according to the invention comprising an active compound of the formula (I-2) is mixed with at least one insecticide selected from the above list.

Very particularly preferably, the suspension concentrate comprising an active compound of the formula (I-2) is mixed with insecticides from the group of the neonicotinyls selected from the group consisting of imidacloprid (cf. EP-A-192 060), thiacloprid (cf. EP-A-235 725), acetamiprid (WO 91/04965), nitenpyram (cf. EP-A-302 389), thiamethoxam (cf. EP-A-580 533), clothianidin (cf. EP-A-376 279) and dinotefuran (cf. EP-A-649845).

Furthermore very particularly preferably, the suspension concentrate comprising an active compound of the formula (I-2) is mixed with insecticides from the group of the pyrethroids.

Furthermore very particularly preferably, the suspension concentrate comprising an active compound of the formula (I-2) is mixed with the insecticide flubendiamide (II-28-1).

These active compounds are known, for example, from The Pesticide Manual 13^{th} edition.

With the aid of the oil-based suspension concentrates according to the invention, it is possible to apply agrochemically active compounds in a particularly advantageous manner to plants and/or their habitat. Here, the agrochemically active compounds comprised in the concentrates unfold better biological activity (in particular better insecticidal activity and/or better compatibility with crop plants) than in the case of application in the faun of the corresponding conventional formulations.

According to the invention, it is possible to treat all plants and parts of plants. Plants are to be understood here as meaning all plants and plant populations such as desired and undesired wild plants or crop plants (including naturally occurring crop plants). Crop plants can be plants which can be obtained by conventional breeding and optimization methods or by biotechnological and genetic engineering methods or combinations of these methods, including the transgenic plants and including the plant cultivars which can or cannot be protected by plant breeders' certificates. Parts of plants are to be understood as meaning all above-ground and below-ground parts and organs of plants, such as shoot, leaf, flower and root, examples which may be mentioned being leaves, needles, stems, trunks, flowers, fruit-bodies, fruits and seeds and also roots, tubers and rhizomes. Parts of plants also include harvested plants and vegetative and generative propagation material, for example seedlings, tubers, rhizomes, cuttings and seeds.

The treatment according to the invention of the plants and parts of plants with the suspension concentrates is carried out directly or by action on their environment, habitat or storage area according to customary treatment methods, for example by dipping, spraying, evaporating, atomizing, brushing-on and, in the case of propagation material, in particular in the case of seeds, furthermore by one- or multi-layer coating.

As already mentioned above, it is possible to treat all plants and their parts according to the invention. In a preferred embodiment, wild plant species and plant cultivars, or those obtained by conventional biological breeding methods, such as crossing or protoplast fusion, and parts thereof, are treated. In a further preferred embodiment, transgenic plants and plant cultivars obtained by genetic engineering methods, if appropriate in combination with conventional methods (Genetically Modified Organisms), and parts thereof are treated. The terms “parts”, “parts of plants” and “plant parts” have been explained above.

Particularly preferably, plants of the plant cultivars which are in each case commercially available or in use are treated according to the invention. Plant cultivars are to be understood as meaning plants having novel properties (“traits”) which have been obtained by conventional breeding, by mutagenesis or by recombinant DNA techniques. These can be cultivars, bio- or genotypes.

Depending on the plant species or plant cultivars, their location and growth conditions (soils, climate, vegetation period, diet), the treatment according to the invention may also result in superadditive (“synergistic”) effects. Thus, for example, reduced application rates and/or a widening of the activity spectrum and/or an increase in the activity of the substances and compositions which can be used according to the invention, better plant growth, increased tolerance to high or low temperatures, increased tolerance to drought or to water or soil salt content, increased flowering performance, easier harvesting, accelerated maturation, higher harvest yields, better quality and/or a higher nutritional value of the harvested products, better storage stability and/or processability of the harvested products are possible which exceed the effects which were actually to be expected.

The transgenic plants or plant cultivars (i.e. those obtained by genetic engineering) which are preferred and to be treated according to the invention include all plants which, in the genetic modification, received genetic material which imparts particularly advantageous useful traits to these plants. Examples of such traits are better plant growth, increased tolerance to high or low temperatures, increased tolerance to drought or to water or soil salt content, increased flowering performance, easier harvesting, accelerated maturation, higher harvest yields, better quality and/or a higher nutritional value of the harvested products, better storage stability and/or processability of the harvested products. Further and particularly emphasized examples of such properties are a better defence of the plants against animal and microbial pests, such as against insects, mites, phytopathogenic fungi, bacteria and/or viruses, and also increased tolerance of the plants to certain herbicidally active compounds. Examples of transgenic plants which may be mentioned are the important crop plants, such as cereals (wheat, rice), maize, soya beans, potatoes, cotton, oilseed rape, beetroot, sugar cane and also fruit plants (with the fruits apples, pears, citrus fruits and grapes), and particular emphasis is given to maize, soya beans, potatoes, cotton and oilseed rape. Traits that are particularly emphasized are the increased defence of the plants against insects by toxins foamed in the plants, in particular those formed in the plants by the genetic material from Bacillus Thuringiensis (for example by the genes CryIA(a), CryIA(b), CryIA(c), CryIIA, CryIIIA, CryIIIB2, Cry9c Cry2Ab, Cry3Bb and CryIF and also combinations thereof) (hereinbelow referred to as “Bt plants”). Traits that are also particularly emphasized are the increased defence of plants against fungi, bacteria and viruses by systemic acquired resistance (SAR), systemin, phytoalexins, elicitors and also resistance genes and correspondingly expressed proteins and toxins. Traits that are furthermore particularly emphasized are the increased tolerance of the plants to certain herbicidally active compounds, for example imidazolinones, sulphonylureas, glyphosate or phosphinotricin (for example the “PAT” gene). The genes in question which impart the desired traits can also be present in combination with one another in the transgenic plants. Examples of “Bt plants” which may be mentioned are maize varieties, cotton varieties, soya bean varieties and potato varieties which are sold under the trade names YIELD GARD® (for example maize, cotton, soya bean), KnockOut® (for example maize), StarLink® (for example maize), Boilgard® (cotton), Nucotn® (cotton) and NewLeaf® (potato). Examples of herbicide-tolerant plants which may be mentioned are maize varieties, cotton varieties and soya bean varieties which are sold under the trade names Roundup Ready® (tolerance to glyphosate, for example maize, cotton, soya bean), Liberty Link® (tolerance to phosphinotricin, for example oilseed rape), IMI® (tolerance to imidazolinones) and STS® (tolerance to sulphonylureas, for example maize). Herbicide-resistant plants (plants bred in a conventional manner for herbicide tolerance) which may be mentioned include the varieties sold under the name Clearfield® (for example maize). Of course, these statements also apply to plant cultivars having these or still-to-be-developed genetic traits, which plants will be developed and/or marketed in the future.

The plants listed can be treated in a particularly advantageous manner with the suspension concentrates according to the invention. The preferred ranges stated above for the suspension concentrates also apply to the treatment of these plants. Particular emphasis is given to the treatment of plants with the suspension concentrates specifically mentioned in the present text.

It has furthermore been found that the compositions according to the invention have a strong insecticidal action against insects which destroy industrial materials.

The following insects may be mentioned as examples and as preferred—but without any limitation:

Beetles, such as Hylotrupes bajulus, Chlorophorus pilosis, Anobium punctatum, Xestobium rufovillosum, Ptilinus pecticornis, Dendrobium pertinex, Ernobius mollis, Priobium carpini, Lyctus brunneus, Lyctus africanus, Lyctus planicollis, Lyctus linearis, Lyctus pubescens, Trogoxylon aequale, Minthes rugicollis, Xyleborus spec. Tryptodendron spec. Apate monachus, Bostrychus capucins, Heterobostrychus brunneus, Sinoxylon spec. Dinoderus minutus;

Hymenopterans, such as Sirex juvencus, Urocerus gigas, Urocerus gigas taignus, Urocerus augur;

Termites, such as Kalotermes flavicollis, Cryptotermes brevis, Heterotermes indicola, Reticulitermes flavipes, Reticulitermes santonensis, Reticulitermes lucifugus, Mastotermes darwiniensis, Zootermopsis nevadensis, Coptotermes formosanus;

Bristletails, such as Lepisma saccharina.

Industrial materials in the present connection are to be understood as meaning non-living materials, such as, preferably, plastics, adhesives, sizes, papers and cardboards, leather, wood and processed wood products and coating compositions.

The ready-to-use compositions may, if appropriate, comprise further insecticides and, if appropriate, one or more fungicides.

With respect to possible additional additives, reference may be made to the insecticides and fungicides mentioned above.

The invention is illustrated by the examples below, without being limited thereby.

### EXAMPLES

### Preparation Examples

### Example 1

To prepare a suspension concentrate,
150.0 g of the compound of the formula (I-2)
100.0 g of Arlatone T(V)
30.0 g of Atlox 4894
5.0 g of Morwet D 425
0.5 g of Silfoam SC 1132
2.0 g of anhydrous citric acid
2.0 g of Vulkanox BHT
   are added with stirring at room temperature to a mixture of
200.0 g of the compound of the formula (II-1) and
510.5 g of sunflower oil.

After the addition has ended, stirring at room temperature is continued for 10 minutes. The homogeneous suspension formed in this manner is subjected initially to coarse grinding and then to fine grinding, giving a suspension in which 90% of the solids particles have a particle size of less than 6 μm.

### Example 2

To prepare a suspension concentrate,
150.0 g of the compound of the formula (I-2)
100.0 g of Arlatone T(V)
20.0 g of Atlox 4894
5.0 g of Morwet D 425
0.5 g of Silfoam SC 1132
2.0 g of anhydrous citric acid
2.0 g of Vulkanox BHT
   are added with stirring at room temperature to a mixture of
200.0 g of the compound of the formula (II-1) and
520.5 g of sunflower oil.

After the addition has ended, stirring at room temperature is continued for 10 minutes. The homogeneous suspension formed in this manner is subjected initially to coarse grinding and then to fine grinding, giving a suspension in which 90% of the solids particles have a particle size of less than 6 μm.

### Example 3

To prepare a suspension concentrate,
150.0 g of the compound of the formula (I-2)
100.0 g of Arlatone T(V)
10.0 g of Atlas G 5000
10.0 g of Synperonic A7
5.0 g of Morwet D 425
0.5 g of Silfoam SC 1132
2.0 g of anhydrous citric acid
2.0 g of Vulkanox BHT
   are added with stirring at room temperature to a mixture of
200.0 g of the compound of the formula (II-1) and
520.5 g of sunflower oil.

After the addition has ended, stirring at room temperature is continued for 10 minutes. The homogeneous suspension formed in this manner is subjected initially to coarse grinding and then to fine grinding, giving a suspension in which 90% of the solids particles have a particle size of less than 6 μm.

### Example 4

To prepare a suspension concentrate,
150.0 g of the compound of the formula (I-2)
100.0 g of Arlatone T(V)
10.0 g of Atlas G 5000
10.0 g of Synperonic A3
5.0 g of Morwet D 425
0.5 g of Silfoam SC 1132
2.0 g of anhydrous citric acid
2.0 g of Vulkanox BHT
   are added with stirring at room temperature to a mixture of
200.0 g of the compound of the formula (II-1) and
520.5 g of sunflower oil.

After the addition has ended, stirring at room temperature is continued for 10 minutes. The homogeneous suspension formed in this manner is subjected initially to coarse grinding and then to fine grinding, giving a suspension in which 90% of the solids particles have a particle size of less than 6 μm.

### Comparative Example I (WO 05/084441)

To prepare a suspension concentrate,
150.0 g of the compound (I-2)
100 g of Arlatone T(V)
80 g of Zephrym PD 2206
20 g of Borresperse NA
0.5 g of Silfoam SC 1132
2.0 g of anhydrous citric acid
2.0 g of Vulkanox BHT
   are added with stirring at room temperature to a mixture of
200 g of alkanol alkoxylate of the formula (2)

CH₃—(CH₂)ₜ—CH₂—O—(—CH₂—CH₂—O—)ᵤ—H (2)

in which
t represents a number from 9 to 12 and
u represents a number from 7 to 9, and
425.5 g of sunflower oil.

After the addition has ended, stirring at room temperature is continued for 10 minutes. The homogeneous suspension formed in this manner is subjected initially to coarse grinding and then to fine grinding, giving a suspension in which 90% of the solids particles have a particle size of less than 6 μm.

### Comparative Example II (Comparative Example I from WO 05/084441)

To prepare a suspension concentrate,
100 g of the compound (I-2)
100 g of polyoxyethylene sorbitol oleate
80 g of a mixture of polyalkoxylated alcohols (Atlox 4894)
20 g of lignosulphonate (Borresperse NA)
0.5 g of polydimethylsiloxane
2.0 g of anhydrous citric acid
2.0 g of 2-6-di-tert-butyl-4-methylphenol
   are added with stirring at room temperature to a mixture of
250 g of the compound RO(EO)₈(PO)₄—H
   in which
   R represents straight-chain or branched alkyl having 12 to 15 carbon atoms,
   EO represents CH₂—CH₂—O and
   PO represents

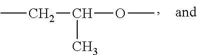

450.0 g of sunflower oil.

After the addition has ended, stirring at room temperature is continued for 10 minutes. The homogeneous suspension formed in this manner is subjected initially to coarse grinding and then to fine grinding, giving a suspension in which 90% of the solids particles have a particle size of less than 6 μm.

In the examples, the following products are used:

TABLE 1

| Trade name | Composition | Source |
|---|---|---|
| Arlatone T(V) | polyoxyethylene sorbitol | Croda |
| | oleate | |
| Atlas G 5000 | propoxylated and ethoxylated | Croda |
| | 4-butoxybutyl alcohol | |
| Atlox 4894 | mixture of 5- to 9-fold | Croda |
| | polyethoxylated (C₁₂-₁₅) fatty | |
| | alcohol and a propoxylated | |
| | and ethoxylated 4-butoxybutyl | |
| | alcohol | |
| Borresperse NA | lignosulphonate | Borregaard |
| Morwet D 425 | naphthalenesulphonate | Akzo Nobel |
| Silfoam SC 1132 | polydimethylsiloxane | Wacker Silicones |
| Synperonic A3 | polyethoxylated (1-4) fatty | Croda |
| | alcohol (C₁₂-₁₅) | |
| Synperonic A7 | polyethoxylated (5-9) fatty | Croda |
| | alcohol (C₁₂-₁₅) | |
| Vulkanox BHT | 2-6-di-tert-butyl-4- | Lanxess AG |
| | methylphenol | |
| Zephrym PD 2206 | polyoxyalkyleneamine | Croda |
| | derivativeoctadecanoic acid, 12- | |
| | hydroxy-, polymer with □- | |
| | hydro-□-hydroxypoly(oxy- | |
| | 1,2-ethanediyl) | |

### Use Example I

### Viscosity of the Formulation as a Function of the Temperature

The complex viscosity of the suspension concentrate is determined using a Bohlin Gemini HR nano viscosimeter from Malvern Instruments, measurement parameters: frequency 0.5 Hz and a desired deformation of 0.002. The temperature is initially, over a period of 200 s, equilibrated to 20° C. and then cooled using a gradient of 1° C./minute.

TABLE 2

Complex viscosity in Pas

| | | Comparative | Comparative |
|---|---|---|---|
| Temperature in ° C. | Example I | example I | example II |
| 20 | 31.4 | 16.3 | 22.4 |
| 18.5 | 34.5 | 26.4 | |
| 16.5 | 39.0 | 9.0 | |
| 15 | 46.6 | 11.7 | |
| 13 | 63.6 | 35.7 | |
| 11 | 69.9 | 171.4 | |
| 10 | 69.9 | 366.8 | |
| 9 | 93.6 | 731.7 | |
| 8 | 97.1 | 1335.0 | |
| 7 | 100.8 | 2456.3 | |
| 6 | 106.1 | 3709.4 | 1200 |

### Use Example II

### Determination of the Biological Activity

To prepare a suitable solution of the preparation, 1 part by weight of the formulated substance is diluted with water to the desired concentration.

Pear trees which are heavily infested by Psylla pyri are treated with the solution of the preparation of the desired concentration. Here, heavily infested means that 40 insects per shoot (per branch) are present.

After the desired period of time, the kill in % is determined. Here, 100% means that all Psylla pyri have been killed; 0% means that none of the insects have been killed.

In this test, for example, the following formulations according to the invention show superior efficacy compared to the formulations known from the prior art:

TABLE 3
Psylla pyri on pear test

| | Concentration | | |
|---|---|---|---|
| | in g/ha/m | Kill in % after | Kill in % after |
| Formulation | crown height | 7 days | 23 days |
| Example 1 | 45 | 69 | 79 |
| Comparative | 45 | 64 | 56 |
| example 1 | | | |
| Example 1 | 75 | 79 | 79 |
| Comparative | 75 | 73 | 78 |
| example 1 | | | |

### Use Example III

### Determination of the Biological Activity

To prepare a suitable solution of the preparation, 1 part by weight of the formulated substance is diluted with water to the desired concentration.

Citrus trees which are heavily infested by scales are treated 3 times with solution of the preparation (in each case with a 2-week intervall between the spray treatments) with in each case 45 g of active compound/ha/m crown height.

After the desired period of time, the quality of 50 citrus fruits is determined. To this end, the number of clean uninfested fruits is determined.

In this test, for example, the following formulations according to the invention show superior efficacy compared to the formulations known from the prior art:

TABLE 4
Scales on citrus fruit test

| | | Fruits having | Fruits having more |
|---|---|---|---|
| | Clean fruits | 1 to 5 scales | than 5 scales |
| Formulation | after 101 days | after 101 days | after 101 days |
| Example 1 | 48 | 2 | 0 |
| Comparative | 44 | 5 | 1 |
| example 1 | | | |

### Use Example IV

### Determination of the Compatibility with Plants

To prepare a suitable solution of the preparation, 1 part by weight of the formulated substance is diluted with water to the desired concentration.

Pear trees which are heavily infested by Psylla pyri are treated with the solution of the preparation having a concentration of 96 g of active compound/ha/m crown height.

After the desired period of time, the damage to the plants (for example necroses) is determined in %.

In this test, for example, the following formulations according to the invention show superior efficacy compared to the formulations known from the prior art:

TABLE 5
Plant compatibility on pear (cv. Packham's Triumph) test

| | Fruits with damage | Fruits with damage |
|---|---|---|
| Formulation | (in %) after 28 days | (in %) after 58 days |
| Example 1 | 2 | 18 |
| Comparative | 10 | 23 |
| example 1 | | |

1. Oil-based suspension concentrates, comprising
at least one compound, solid at room temperature, of the formula (I) 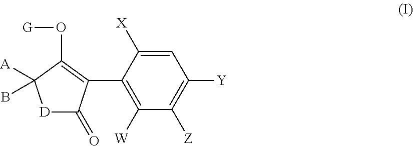
in which
X represents halogen, alkyl, alkoxy, haloalkyl, haloalkoxy or cyano,
W, Y and Z independently of one another represent hydrogen, halogen, alkyl, alkoxy, haloalkyl, haloalkoxy or cyano,
A represents hydrogen, in each case optionally halogen-substituted alkyl, alkoxyalkyl, saturated, optionally substituted cycloalkyl in which optionally at least one ring atom is replaced by a heteroatom,
B represents hydrogen or alkyl,
or
A and B together with the carbon atom to which they are attached represent a saturated or unsaturated, unsubstituted or substituted cycle which optionally contains at least one heteroatom,
D represents NH or oxygen,
G represents hydrogen (a) or represents one of the groups 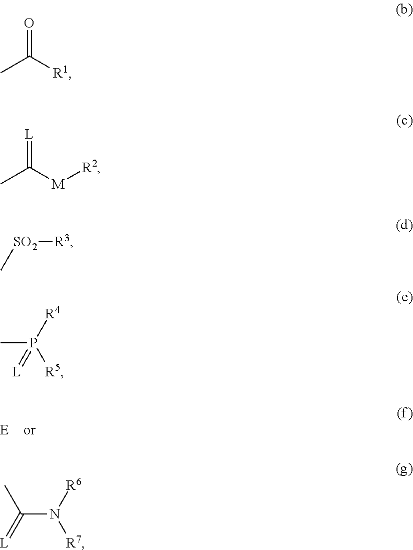
in which
E represents a metal ion or an ammonium ion,
L represents oxygen or sulphur,
M represents oxygen or sulphur,
R¹ represents in each case optionally halogen-substituted alkyl, alkenyl, alkoxyalkyl, alkylthioalkyl, polyalkoxyalkyl or optionally halogen-, alkyl- or alkoxy-substituted cycloalkyl which may be interrupted by at least one heteroatom, in each case optionally substituted phenyl, phenylalkyl, hetaryl, phenoxyalkyl or hetaryloxy-alkyl,
R² represents in each case optionally halogen-substituted alkyl, alkenyl, alkoxyalkyl, polyalkoxyalkyl or represents in each case optionally substituted cycloalkyl, phenyl or benzyl,
R³ represents optionally halogen-substituted alkyl or optionally substituted phenyl,
R⁴ and R⁵ independently of one another represent in each case optionally halogen-substituted alkyl, alkoxy, alkylamino, dialkylamino, alkylthio, alkenylthio, cyclo-alkylthio or represent in each case optionally substituted phenyl, benzyl, phenoxy or phenylthio and
R⁹ and R⁷ independently of one another represent hydrogen, in each case optionally halogen-substituted alkyl, cycloalkyl, alkenyl, alkoxy, alkoxyalkyl, represent optionally substituted phenyl, represent optionally substituted benzyl or together with the nitrogen atom to which they are attached represent an optionally substituted ring which is optionally interrupted by oxygen or sulphur
in the form of their isomer mixtures or pure isomers,
at least one penetrant of the formula (II)
R⁸—O—(—PO-)q-(-EO-)p-R⁹ (II)
in which
R⁸ represents straight-chain or branched alkyl having 4 to 20 carbon atoms,
R⁹ represents H, methyl, ethyl, n-propyl, isopropyl, n-butyl, isobutyl, t-butyl, n-pentyl or n-hexyl,
EO represents CH₂—CH₂—O—,
PO represents 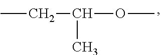
p represents a number from 4 to 8 and
q represents a number from 6 to 10,
at least one vegetable oil,
at least one nonionic surfactant selected from the group consisting of
polyethylene oxide polypropylene oxide 4-butoxybutyl ether,
polyethylene glycol ethers of straight-chain alcohols,
products of the reaction of fatty acids with ethylene oxide and
mixtures of these abovementioned surfactants and/or
at least one anionic surfactant.

2. Suspension concentrates according to claim 1, characterized in that they comprise a penetrant of the formula (II)
R⁸—O—(—PO-)_{q}-(-EO—)ₚ—R⁹ (II)
in which
R⁸ represents n-hexyl, isohexyl, n-octyl, isooctyl, 2-ethylhexyl, nonyl, isononyl or decyl,
R⁹ represents H,
EO represents CH₂—CH₂—O—,
PO represents 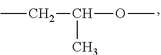
p represents a number from 5 to 7 and
q represents a number from 7 to 9.

3. Suspension concentrates according to one or more of claims 1 and 2, characterized in that they comprise, as penetrant, 2-ethylhexyl alkoxylate of the formula (II-1)

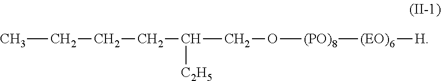

4. Suspension concentrates according to one or more of claims 1, 2 and 3, characterized in that they comprise, as vegetable oil, at least one oil selected from the group consisting of sunflower oil, rapeseed oil, maize oil, olive oil and soyabean oil.

5. Suspension concentrates according to one or more of claims 1, 2, 3 and 4, characterized in that they comprise, as vegetable oil, sunflower oil.

6. Suspension concentrates according to one or more of claims 1, 2, 3, 4 and 5, characterized in that they comprise spirotetramate.

7. Suspension concentrates according to one or more of claims 1, 2, 3, 4, 5 and 6, characterized in that the content
of the compound of the formula (I) is from 5 to 30% by weight,
of penetrant of the formula (II) is from 5 to 30% by weight,
of vegetable oil is from 20 to 55% by weight,
of surfactants is from 1 to 25% by weight,
of additives is from 0 to 25% by weight.

8. Process for preparing suspension concentrates according to one or more of claims 1, 2, 3, 4, 5, 6 and 7, characterized in that the ingredients mentioned in claims 1, 2, 3, 4, 5, 6 and/or 7 and optionally one or more additives from the groups of the emulsifiers, the antifoams, the preservatives, the antioxidants, the colorants and/or the inert fillers are mixed with one another and the resulting suspension is then optionally ground.

9. Use of suspension concentrates according to one or more of claims 1, 2, 3, 4, 5, 6 and 7 for applying the compounds of the formula (I) comprised therein to plants and/or their habitat.

10. Use of suspension concentrates according to one or more of claims 1, 2, 3, 4, 5, 6 and 7 for controlling insects.

11. Compositions, characterized in that they comprise a suspension concentrate according to one or more of claims 1, 2, 3, 4, 5, 6 and 7 and extenders and/or surfactants.
